(19) United States
(12) Patent Application Publication
(10) Pub. No.: US 2019/0260600 A1
(43) Pub. Date: Aug. 22, 2019

(54) Extended Failure Codes Over Gx

(71) Applicant: Telefonaktiebolaget LM Ericsson (publ), Stockholm (SE)

(72) Inventors: Erik Wikström, Göteborg (SE); Sven-Ove Emanuelsson, Nol (SE); Susana Fernandez Alonso, Madrid (ES); Jiehong Yang, Mölndal (SE)

(21) Appl. No.: 16/092,275

(22) PCT Filed: Apr. 15, 2016
(86) PCT No.: PCT/EP2016/058362

§ 371 Date: Oct. 9, 2018

(51) Int. Cl. H04L 12/14; H04M 15/00

(52) U.S. Cl. CPC H04L 12/1407; H04M 15/66; H04M 15/64; H04M 15/56

(57) ABSTRACT

The invention relates to a Policy and Charging Enforcement Function (PCEF) and a method of the PCEF in a communications network of indicating to a Policy and Charging Rules Function (PCRF) charging information of a 5 subscriber received from an Online Charging System (OCS). The invention further relates to a PCRF and a method of the PCRF in a communications network of acquiring OCS charging information of a subscriber. In a first aspect, a method of a PCEF (20) in a communications network (10) of indicating to a PCRF (15) charging information of a subscriber (16) received from an OCS (21) is provided. The method comprises receiving (S102), from the OCS, the charging information of the subscriber requesting a service in the communications network, and submitting (S103), over Gx reference point to the PCRF, a Rule-Failure-Code associated with the charging information received from the OCS.

### TECHNICAL FIELD

The invention relates to a Policy and Charging Enforcement Function (PCEF) and a method of the PCEF in a communications network of indicating to a Policy and Charging Rules Function (PCRF) charging information of a subscriber received from an Online Charging System (OCS).

The invention further relates to a PCRF and a method of the PCRF in a communications network of acquiring OCS charging information of a subscriber.

Moreover, the invention relates to computer programs comprising computer-executable instructions for causing the PCEF and the PCRF, respectfully, to perform steps of the methods according to embodiments, when the computer-executable instructions are executed on a respective processing unit included in the PCEF and the PCRF.

The invention further relates to computer program products comprising computer readable mediums, the computer readable mediums having the computer programs of the PCEF and the PCRF, respectively, embodied thereon.

### BACKGROUND

In a 3rd Generation Partnership Project (3GPP) communication system, Policy and Charging Control (PCC) rules are applied for charging subscribers for utilizing communication services in the system as set out e.g. in 3GPP specification TS 29.212.

In an Evolved 3GPP communication system, commonly referred to as a Long Term Evolution (LTE) system, network operators can decide to charge Voice over LTE (VoLTE) video services as part of the subscribers' existing data plan bundles.

While Internet Protocol Multimedia Subsystem (IMS) charging is applied for voice and Session Initiation Protocol (SIP) signaling traffic, charging for a video bearer is taken care of by nodes in a Packet Core network, referred to as an Evolved Packet Core (EPC) network forming part of an Evolved Packet System (EPS) in case of LTE. Charging of VoLTE related services is thus partly performed in the EPC and partly outside the EPC.

A Policy and Charging Rules Function (PCRF) is a functional element that encompasses policy control decision and flow based charging control functionalities. The PCRF provides e.g. network control regarding service to data flow detection, Quality of Service (QoS) and flow based charging towards a Policy and Charging Enforcement Function (PCEF). The PCRF receives session and media related information from an Application Function (AF) and informs AF of traffic plane events. The PCRF also provides PCC rules to the PCEF via a so called Gx reference point (also referred to as the Gx interface). The terms “interface” and “reference point” will be used interchangeably throughout the application to denote the same network element.

The PCRF PCC rule decisions may for instance be based on one or more of session, media and subscriber related information, IP connectivity access network (IP-CAN), IP flow mobility routing rules , service related data, etc.

The PCEF is a functional element in the EPC that encompasses policy enforcement and flow based charging functionalities. This functional element is located in a Packet Data Network Gateway (PGW) in EPS (or alternatively in a Gateway GPRS Support Node (GGSN) in a General Packet Radio Service (GPRS) case). It provides i.a. control over the user plane traffic handling at the appropriate gateway and its QoS and online and offline charging interactions.

From an Online Charging System (OCS), the PCEF receives indications of remaining credits of a subscriber utilizing services in the system. When the PCEF receives an indication from the OCS that a subscriber is out of credits in the form of a Final-Unit-Indicator (FUI) for a certain service data flow, its behavior depends on a Final-Unit-Action (FUA) also submitted by the OCS. The OCS may request actions to be performed for the service data flow such as for example TERMINATE, REDIRECT, or RESTRICT ACCESS. The PCEF may thus e.g. decide to not allow the service data flow to pass through the gateway. The PCRF is not part in the actions taken by the PCEF based on such indications.

The PCEF may also receive other indications, commonly referred to as result codes, from the OCS regarding the services for which the PCC rules are provisioned. Different result codes typically imply different handling of service flows and the PCRF may apply different policies accordingly.

With respect to the “out-of-credit” scenario described hereinabove, when the OCS detects that the subscriber is about to run out of credits, it shall indicate so to the PCEF such that the service is terminated, redirected or restricted once the last credit is consumed. The PCRF is not part in the termination, redirection or restriction taken by the PCEF based on such indications.

There are other scenarios where the user service can be changed or even blocked by the PCEF due to error codes such as “Credit Limit Reached”, “Service Denied”, etc., received from OCS. The PCRF is not part of the changing or blocking of user service done by the PCEF.

In the event that a subscriber is out of credit, in case PCEF receives error codes instead of FUI and FUA Attribute-Value Pairs (AVPs), PCEF has to enforce actions such as Mocking, redirection or restriction based on the decision from the OCS. However, the PCRF does not receive any corresponding error codes from the OCS and may therefore be unable to take proper actions.

Taking the VoLTE video bearer as an example, in case the video bearer is charged to the PCEF by the OCS via a so called Gy reference point, and the error code for a Rating Group (RG) associated with the PCC rule, i.e. how a service is charged, for instance cost of a particular service per minute or byte, for the video bearer stipulates that the data flow shall be dropped by the PCEF, it is important that such action somehow is reported to the AF so the data flow can be terminated. The PCRF should also remove the corresponding PCC rule. However, the PCRF does not receive any corresponding error code from the OCS.

### SUMMARY

An object of the present invention is to solve, or at least mitigate, this problem in the art and to provide an improved method of reporting charging related information from a PCEF to a PCRF.

This object is attained in a first aspect of the invention by a method of a Policy and Charging Enforcement Function (PCEF) in a communications network of indicating to a Policy and Charging Rules Function (PCRF) charging information of a subscriber received from an Online Charging System (OCS). The method comprises receiving, from the OCS, the charging information of the subscriber requesting a service in the communications network, and submitting, over Gx reference point to the PCRF, a Rule-Failure-Code associated with the charging information received from the OCS.

This object is attained in a second aspect of the invention by a PCEF configured to indicate to a PCRF charging information of a subscriber received from an OCS in a communications network. The PCEF comprises a processing unit and a memory, which memory contains instructions executable by the processing unit, whereby the PCEF is operative to receive, from the OCS, the charging information of the subscriber requesting a service in the communications network, and submit, over Gx reference point to the PCRF, a Rule-Failure-Code associated with the charging information received from the OCS.

This object is attained in a third aspect of the invention by a method of a PCRF in a communications network of acquiring OCS charging information of a subscriber. The method comprises receiving, over Gx reference point from a PCEF, a Rule-Failure-Code associated with the OCS charging information of the subscriber requesting a service in the communications network.

This object is attained in a fourth aspect of the invention by a PCRF configured to acquire OCS charging information of a subscriber in a communications network. The PCRF comprises a processing unit and a memory, which memory contains instructions executable by the processing unit, whereby the PCRF is operative to receive, over Gx reference point from a PCEF, a Rule-Failure-Code associated with the OCS charging information to of the subscriber requesting a service in the communications network.

Advantageously, by introducing Rule-Failure-Codes to be used over the Gx interface for reporting of charging-related information of the OCS from the PCEF to the PCRF, which Rule-Failure-Codes already are available and in use for reporting to the PCRF in connection with so called Application Based Charging (ABC) from a Traffic Detection Function (TDF) over an interface knowns as Sd reference point (also referred as the Sd interface) as discussed e.g. in 3GPP specification TS 29.212, great flexibility is provided in reporting subscriber charging-related information of the OCS to the PCRF.

Further advantageous is that since the Rule-Failure-Codes introduced over the Gx interface already are available in the communications network, there is not need to create and introduce new codes, which also would require modifying and updating functional entities—in particular the PCRF—to correctly interpret the new codes.

In an embodiment, the Rule-Failure-Code(s) to be submitted to the PCRF from the PCEF are selected from the already available codes used for ABC reporting over the Sd interface from a TDF, the codes consisting of:
CM_END_USER_SERVICE_DENIED (19)
CM_CREDIT_CONTROL_NOT_APPLICABLE (20)
CM_AUTHORIZATION_REJECTED (21)
CM_USER_UNKNOWN (22)
CM_RATING _FAILED (23),
   where the numerical indication in parentheses given after each code is the number used in the most current specification TS 29.212, version 13.5.0 of March 2016.

In still an embodiment, the Rule-Failure-Code(s) reported from the PCEF to the PCRF over the Gx interface is triggered by Event-Trigger AVP denoted “CREDIT_MANAGEMENT_SESSION_FAILURE (46)”. When such an Event-Trigger AVP is sent from the PCRF to the PCEF the Event-Trigger AVP indicates an event that shall cause a re-request of PCC rules. When sent from the PCEF to the PCRF the Event-Trigger AVP indicates that the corresponding event has occurred at the PCEF.

In yet an embodiment, a new Rule-Failure-Code is introduced indicating that a subscriber credit limit is being reached. This new code is in the following referred to as CM_CREDIT_LIMIT_REACHED.

In another embodiment, the PCEF advantageously receives from the PCRF, in response to the Rule-Failure-Code submitted to the PCRF, an indication that at least one Policy and Charging Control (PCC) rule is changed for the subscriber. For instance, in reply to reporting CM_END_USER_SERVICE_DENIED for a particular subscriber service to the PCRF, the PCEF receives an instruction that the PCC rule for the service should be removed, thereby indicating that the service is to be terminated.

In yet a further embodiment, the PCRF sends over the Rx interface, a message notifying an Application Function (AF) about the Rule-Failure-Code previously received from the PCEF to advantageously inform the AF that an error has occurred related to a charging condition different from out of credit. The AF can then decide to terminate the service or change the conditions of the service depending on whether the PCRF determines to remove the PCC rule or change it.

Further provided is a computer program comprising computer-executable instructions for causing the PCEF to perform steps according to an embodiment of the first aspect of the invention, when the computer-executable instructions are executed on a processing unit included in the PCEF.

Further provided is a computer program product comprising a computer readable medium, the computer readable medium having the computer program of the PCEF embodied thereon.

Still further provided is a computer program comprising computer-executable instructions for causing the PCRF to perform steps according to an embodiment of the third aspect of the invention, when the computer-executable instructions are executed on a processing unit included in the PCRF.

Yet further provided is a computer program product comprising a computer readable medium, the computer readable medium having the computer program of the PCRF embodied thereon.

These and further embodiments of the invention will be discussed in more detail in the detailed description hereinbelow with reference made to the accompanying drawings.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 shows a schematic overview of an exemplifying wireless communication system in which the present invention can be implemented;

FIG. 2 shows further subscriber charging-related functional entities of the wireless communication system illustrated in FIG. 1;

FIG. 3 shows a timing diagram illustrating an embodiment of a method of a PCEF of indicating to a PCRF charging information of a subscriber received from an OCS;

FIG. 4 shows a timing diagram illustrating a further embodiment of a method of a PCEF of indicating to a PCRF charging information of a subscriber received from an OCS;

FIG. 5 illustrates a PCEF according to an embodiment; FIG. 6 illustrates a PCRF according to an embodiment;

FIG. 7 illustrates a PCEF according to a further embodiment; and

FIG. 8 illustrates a PCRF according to a further embodiment.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

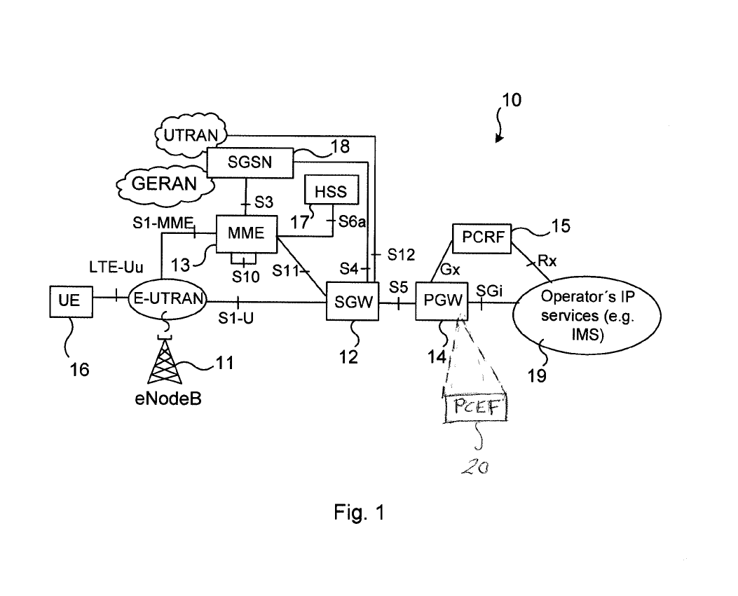

FIG. 1 shows a schematic overview of an exemplifying wireless communication system 10 in which embodiments of the present invention can be implemented. The wireless communication system 10 is an Long Term Evolution (LTE) based system. It should be pointed out that the terms “LTE” and “LTE based” system is here used to comprise both present and future LTE based systems, such as, for example, advanced LTE systems. It should be appreciated that although FIG. 1 shows a wireless communication system 10 in the form of an LTE based system, the example embodiments herein may also be utilized in connection with other wireless communication systems, such as e.g. Global System for Mobile Communications (GSM) or Universal Mobile Telecommunications System (UMTS), comprising nodes and functions that correspond to the nodes and functions of the system in FIG. 1.

The wireless communication system 10 comprises a base station in the form of an eNodeB 11, operatively connected to a Mobility Management Entity (MME) 13 and to a Serving Gateway (SGW) 12, in turn operatively connected to the MME 13, and a Packet Data Network Gateway (PGW) 14, which in turn is operatively connected to a PCRF 15. The eNodeB 11 is a radio access node that interfaces with a mobile radio terminal, commonly referred to as a User Equipment (UE) 16 in the form of e.g. smart phones, tablets, laptops, gaming consoles, etc.

The PGW 14 provides connectivity to the UEs to external Packet Data Networks (PDNs) 19 by being the point of exit and entry of traffic for the UE with respect to the PDNs. A UE may have simultaneous connectivity with more than one PGW for accessing multiple PDNs, or multiple connections to a single PGW for accessing multiple PDNs.

The eNodeB(s) of the system form the Evolved Universal Terrestrial Radio Access Network (E-UTRAN) for LTE communicating with the UE over an air interface such as LTE-Uu. The core network in LTE is known as EPC, and the EPC together with the E-UTRAN is referred to in LTE as the EPS. The SGW 12 routes and forwards user data packets over the S1-U interface, whilst also acting as the mobility anchor for the user plane during inter-eNodeB handovers and as the anchor for mobility between LTE and other 3GPP technologies (terminating S4 interface and relaying the traffic between 2G/3G systems and the PGW 14). For idle state UEs, the SGW 12 terminates the downlink (DL) data path and triggers paging when DL data arrives for the UE 16, and further manages and stores UE contexts, e.g. parameters of the IP bearer service, network internal routing information. It also performs replication of the user traffic in case of lawful interception. The SGW 12 communicates with the MME 13 via interface S11 and with the PGW 14 via to the S5 interface. Further, the SGW 12 may communicate with the UMTS radio access network Universal Terrestrial Radio Access Network (UTRAN) and with the GSM EDGE (“Enhanced Data rates for GSM Evolution”) Radio Access Network (GERAN) via the S12 interface.

The MME 13 is responsible for idle mode UE tracking and paging procedure including retransmissions. It is involved in the bearer activation/deactivation process and is also responsible for choosing the SGW 12 for a UE 16 at the initial attach and at time of intra-LTE handover involving core network node relocation. It is responsible for authenticating the user by interacting with the Home Subscriber Server (HSS) 17. The Non-Access Stratum (NAS) signaling terminates at the MME 13 and it is also responsible for generation and allocation of temporary identities to UEs via the S1-MME interface. It checks the authorization of the UE 16 to camp on the service provider's Public Land Mobile Network (PLMN) and enforces UE roaming restrictions. The MME 13 is the termination point in the network for ciphering/integrity protection for NAS signaling and handles the security key management. Lawful interception of signaling is also supported by the MME. The MME 13 also provides the control plane function for mobility between LTE and 2G/3G access networks with the S3 interface terminating at the MME 13 from a Serving GPRS (“General Packet Radio Service”) Support Node (SGSN) 18. The MME 13 also terminates the S6a interface towards the home HSS 17 for roaming UEs. Further, there is an interface S10 configured for communication between MMEs for MME relocation and MME-to-MME information transfer.

The PGW 14 provides connectivity to the UE 16 to external PDNs 19 by being the point of exit and entry of traffic for the UE 16. The PGW 14 performs policy enforcement, packet filtering for each user, charging support, lawful interception and packet screening. Another key role of the PGW 14 is to act as the anchor for mobility between 3GPP and non-3GPP technologies such as WiMAX and 3GPP2 (CDMA 1× and EvDO), and also for handover involving core network node relocation. The interface between the PGW 14 and the packet data network is referred to as the SGi. The packet data network may be an operator external public or private packet data network or an intra to operator packet data network, e.g. for provision IP Multimedia Subsystem (IMS) services.

The PCRF 15 determines policy rules in real-time with respect to the radio terminals of the system. This may e.g. include aggregating information in real-time to and from the core network and operational support systems, etc. of the system so as to support the creation of rules and/or automatically making policy decisions for user radio terminals currently active in the system based on such rules or similar. The PCRF 15 provides the PGW 14 with such rules and/or policies or similar to be used by the PGW acting as a Policy and Charging Enforcement Function (PCEF) 20 via interface Gx. The PCRF further communicates with the packet data network via the Rx interface.

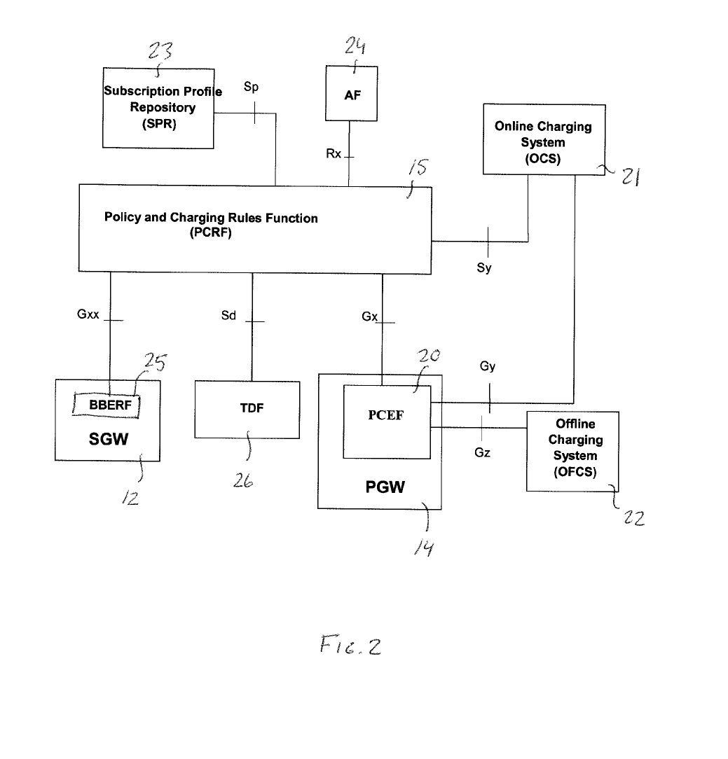

FIG. 2 illustrates further subscriber charging-related functional entities of the wireless communication system to described with reference to FIG. 1. The basic features of FIG. 2 are commonly known and further information relating to FIG. 2 can be found in the 3GPP specification TS 23.203. Some particular features of FIG. 2 are discussed in some detail below.

In addition to the previously described PCRF 15, the PGW 14 accommodating the PCEF 14 and the SGW 12, FIG. 2 shows an Online Charging System (OCS) 21 enabling charging of subscribers utilizing services in the communication system, which may be connected to the PCRF via a Sy reference point and to the PGW 14 and the PCEF 20 via a Gy reference point.

The OCS 21 is typically applicable to pre-paid services and can affect a subscriber session in real-time. Further shown is an Offline Charging System (OFCS) 22 usually used for post-paid services for which the subscriber receives a bill, the OFCS 22 being connect to the PGW 14 via reference point Gz.

Further illustrated in FIG. 2 are a Subscription Profile Repository (SPR) 23 containing all subscriber/subscription related information needed for subscription-based policies of the PCRF 15 to which it is connected via an Sp reference point, and an Application Function (AF) providing applications to the UE 16, such as for instance video calls, that require dynamic policy and/or charging control connected to the PCRF 15 via an Rx reference point.

Moreover, FIG. 2 shows a Bearer Binding and Event Reporting Function (BBERF) 25 accommodated in the SGW 12 and connected to the PCRF 15 via a Gxx reference point i.a. for reporting events to the PCRF 15 based on event triggers installed by the PCRF 15. Finally illustrated is a Traffic Detection Function (TDF) 26, connected to the PFRC 15 via the Sd reference point, which performs application detection and reporting of detected application and its service data flow description to the PCRF 15.

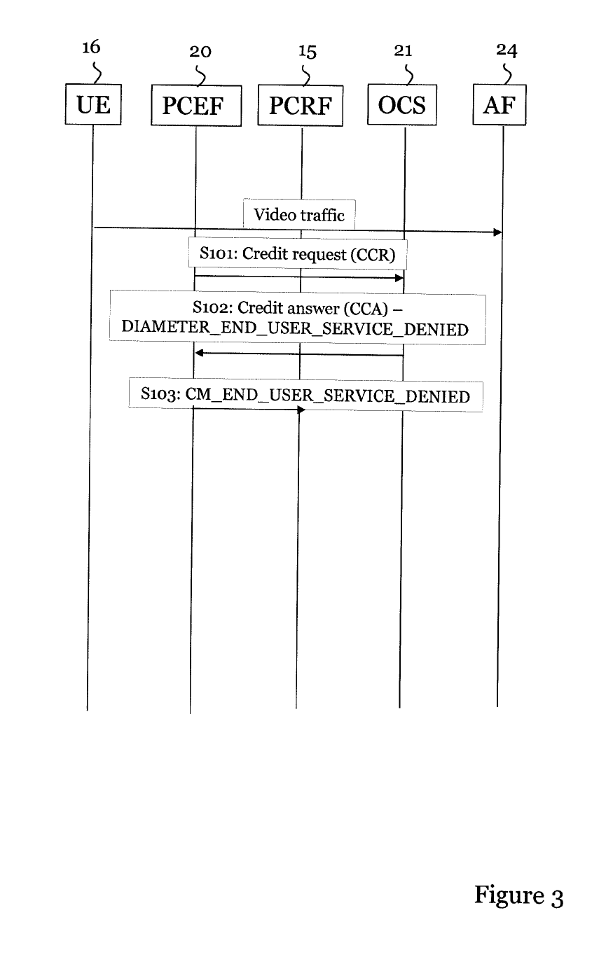

FIG. 3 shows a timing diagram illustrating an embodiment of a method of a PCEF 20 of indicating to PCRF 15 charging information of a subscriber (illustrated by means of UE 16) received from an OCS 21. In this exemplifying embodiment, a video traffic session is set up between the UE 16 and an appropriate AF 24, for instance a YouTube server. It should be noted that this may be preceded by a fairly great number of steps (not shown) involving the functional entities in FIG. 3 for initially setting up the video session.

Now, the PCEF 20 sends a Credit Control Request (CCR) to the OCS 21 over the Gy interface in step S101, and the OCS 21 replies with a Credit Control Answer (CCA) in step S102. Hence, the OCS 21 reports charging information of the subscriber/UE 16 to the PCEF 20 via the Gy interface in step S102, in this particular exemplifying embodiment in the form of an DIAMETER_END_USER_SERVICE_DENIED message indicating that the service request is denied due to service restrictions. For instance, the subscriber may only have access to e.g. YouTube at certain times of the day.

In response to this message from the OCS 21, the PCEF 20 advantageously sends an appropriate Rule-Failure-Code to the PCRF 15 in step S103 over the Gx interface, in this particular case CM_END_USER_SERVICE_DENIED, which indicates that the OCS 21 denied the service request due to service restrictions, since the subscriber is not granted access at this particular time of the day. The PCRF 15 may accordingly take a proper PCC rule decision to based on the reported Rule-Failure-Code.

In another example, if the OCS 21 would respond with e.g. a DIAMETER_CREDIT_LIMIT_REACHED, in step S102, the PCEF would submit a CM_END_USER_SERVICE_DENIED (described in more detail in the following) to the PCRF 15 in step S103. Hence, charging information of the OCS 21 is advantageously indicated to the PCRF 15 by the PCEF 20 sending an appropriate Rule-Failure-Code associated with the charging information in step 103.

It should be noted the Rule-Failure-Codes disclosed herein can be used for many other cases in addition to a VoLTE video service, when the PCEF should enforce credit management failure related actions as reported by the OCS for services associated with PCC rules.

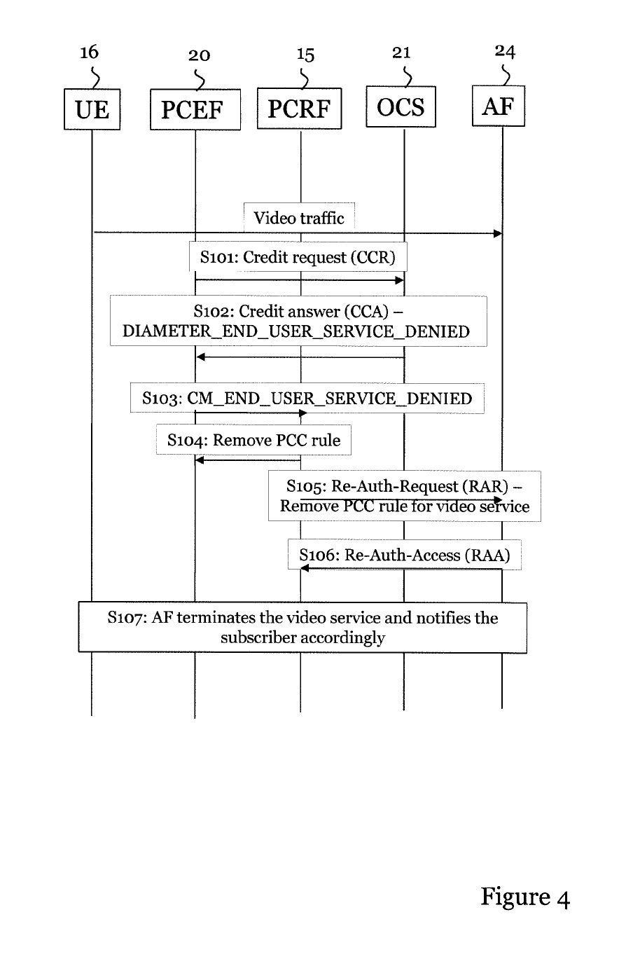

FIG. 4 shows a further timing diagram being a continuation of the timing diagram of FIG. 3, which illustrates a further embodiment of the invention. After having received the Rule-Failure-Code denoted CM END USER SERVICE DENIED, the PCRF 15 submits in step S104 via the Gx interface an indication to the PCEF 20 that at least one PCC rule is changed or even removed for the subscriber in response to the Rule-Failure-Code received in step S103. Hence, the PCRF 15 can remove the rule in order to terminate the service, or change the rule such that the service e.g. is received at a limited capability (such as low quality video).

In this particular embodiment, an instruction to remove the PCC rule for the subscriber is submitted in step S104, indicating that the video session should be terminated due to the previously discussed service restrictions. In step S105, the PCRF 15 further optionally sends via the Rx interface to the AF 24 a so called Re-Auth-Request (RAR) message instructing that the video service should be terminated, which is acknowledged to the PCRF 15 by the AF 24 by means of a Re-Auth-Answer (RAA) message in step S106. Alternatively, steps S105 and S106 could be performed before step S104 of removing the PCC rule.

Finally in step S107, the AF 24 terminates the video service and notifies the subscriber accordingly.

In a further embodiment, any one or more of the following Rule-Failure-Codes may be reported in step S103 by the PCEF 20 to the PCRF 15 over the Gx interface to report the appropriate charging information received from the OCS 21 in step S102 (in addition to the Rule-Failure-Code described with reference to FIGS. 3 and 4):
CM_CREDIT_CONTROL_NOT_APPLICABLE
   This value is used to indicate that the charging system determined that the service can be granted to the end user but no further credit control is needed for the service (e.g. service is free of charge or is treated for offline charging).
CM_AUTHORIZATION_REJECTED
   This value is used to indicate that the charging system denied the service request in order to terminate the service for which credit is requested.
CM_USER_UNKNOWN
   This value is used to indicate that the specified end user could not be found in the charging system.
CM_RATING_FAILED
   This value is used to inform the PCRF that the charging system cannot rate the service request due to insufficient rating input, incorrect AVP combination or due to an AVP or an AVP value that is not recognized or supported in the rating.

As can be deducted, charging related error reporting to the PCRF 15 over the Gx reference point is advantageously facilitated by introducing these Rule-Failure-Codes (currently only available for ABC from the TDF 26 over the Sd reference point) for submission over the Gx reference point from the PCEF 20.

In yet an embodiment, submission of the Rule-Failure-Code over the Gx reference point is triggered by Event-Trigger AVP denoted CREDIT_MANAGEMENT_SESSION_FAILURE. Thus, the Rule-Failure-Code(s) reported from the PCEF to the PCRF over the Gx interface is triggered by CREDIT_MANAGEMENT_SESSION_FAILURE. When such an Event-Trigger AVP is sent from the PCRF 15 to the PCEF 20 the Event-Trigger AVP indicates an event that shall cause a re-request of PCC rules. When sent from the PCEF 20 to the PCRF 15, the Event-Trigger AVP indicates that the corresponding event has occurred at the PGW 14.

When used in a CCR command, CREDIT_MANAGEMENT_SESSION_FAILURE indicates that a transient/permanent failure has been detected in the OCS 21. If the failure does not apply to all PCC Rules, the affected PCC Rules are indicated within a Charging-Rule-Report AVP, with a PCC-Rule-Status set to value ACTWE and the Rule-Failure-Code AVP set to the corresponding value as reported by the OCS 21. If the failure applies to the session, Credit-Management-Status shall be set to the corresponding value as reported by the OCS 21.

In still an embodiment, a new Rule-Failure-Code is introduced indicating that a subscriber credit limit is being reached denoted CM_CREDIT_LIMIT_REACHED.

Again with reference to FIG. 4, in a further embodiment, the PCRF sends over the Rx interface, for instance in step S105, a message notifying the AF 24 about the Rule-Failure-Code received in step 103 to advantageously allow the AF 24 to know that there is an error related to a charging condition different from out of credit. The AF 24 can then decide to terminate the service or change the conditions of the service depending on whether the PCRF determines to remove the PCC rule or change it.

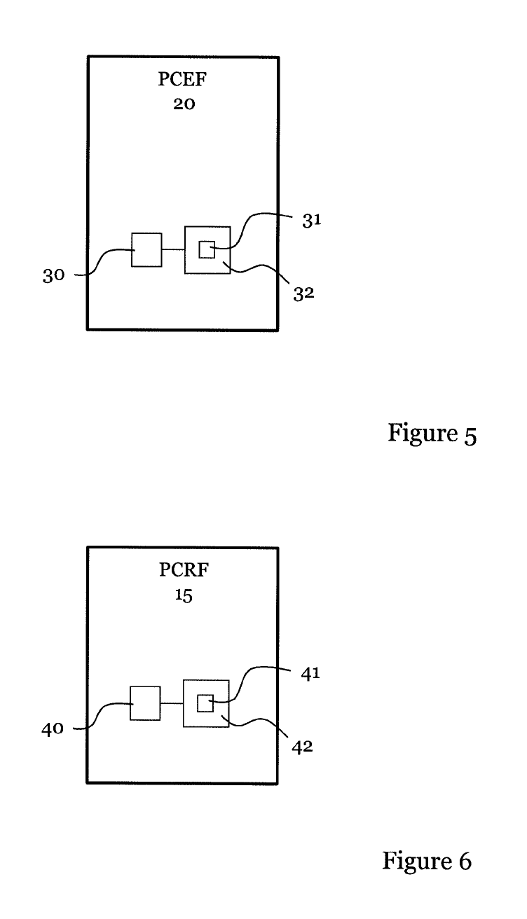

With reference to FIGS. 5 and 6, the steps of the method performed by the PCEF 20 and PCRF 15, respectively, as previously discussed with reference to FIGS. 3 and 4, according to embodiments are in practice performed by a processing unit 30, 40 embodied in the form of one or more microprocessors arranged to execute a computer program 31, 41 downloaded to a suitable storage medium 32, 42 associated with the microprocessor, such as a Random Access Memory (RAM), a Flash memory or a hard disk drive. The respective processing unit 30, 40 is arranged to cause the PCEF 20 and the PCRF 15 to carry out the method according to embodiments when the appropriate computer program 30, 40 comprising computer-executable instructions is downloaded to the storage medium 32, 42 and executed by the processing unit 30, 40. The storage medium 32, 42 may also be a computer program product comprising the computer program 31, 41. Alternatively, the computer program 31, 41 may be transferred to the storage medium 32, 42 by means of a suitable computer program product, such as a Digital Versatile Disc (DVD) or a memory stick. As a further alternative, the computer program 31, 41 may be downloaded to the storage medium 32, 42 over a network. The processing unit 30, 40 may alternatively be embodied in the form of a digital signal processor (DSP), an application specific integrated circuit (ASIC), a field-programmable gate array (FPGA), a complex programmable logic device (CPLD), etc.

Hence, the functionality of the PCEF 20 and the PCRF 15 may be embodied in software, hardware, or a combination thereof.

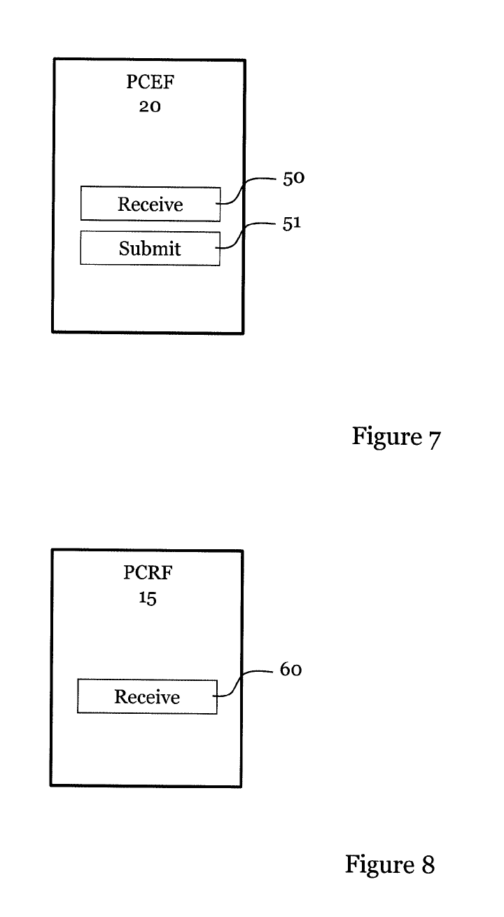

FIG. 7 illustrates a PCEF 20 configured to indicate to a PCRF charging information of a subscriber received from an OCS according to a further embodiment. The PCEF 20 comprises receiving means 50 adapted to receive, from the OCS, the charging information of the subscriber requesting a service in a communications network. The PCEF 20 further comprises submitting means 51 adapted to submit, over Gx reference point to the PCRF, a Rule-Failure-Code indicating the charging information received from the OCS.

The receiving means 50 and submitting means 51 may comprise a communications interface for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

FIG. 8 illustrates a PCRF 15 configured to acquire OCS charging information of a subscriber according to a further embodiment. The PCRF 15 comprises receiving means 60 adapted to receive, over Gx reference point from a PCEF, a Rule-Failure-Code indicating the OCS charging information of the subscriber requesting a service in a communications network.

The receiving means 60 may comprise a communications interface for receiving and providing information, and further a local storage for storing data, and may (in analogy with that previously discussed) be implemented by a processor embodied in the form of one or more microprocessors arranged to execute a computer program downloaded to a suitable storage medium associated with the microprocessor, such as a RAM, a Flash memory or a hard disk drive.

The invention has mainly been described above with reference to a few embodiments. However, as is readily appreciated by a person skilled in the art, other embodiments than the ones disclosed above are equally possible within the scope of the invention, as defined by the appended patent claims.

1-26. (canceled)

27. A method of a Policy and Charging Enforcement Function (PCEF) in a communications network of indicating, to a Policy and Charging Rules Function (PCRF), charging information of a subscriber received by the PCEF from an Online Charging System (OCS), the method comprising:
receiving, from the OCS, the charging information of the subscriber requesting a service in the communications network; and
submitting, over a Gx reference point to the PCRF, a Rule-Failure-Code associated with the charging information received from the OCS.

28. The method of claim 27, wherein the Rule-Failure-Code is:
CM_END_USER_SERVICE_DENIED;
CM_CREDIT_CONTROL_NOT_APPLICABLE;
CM_AUTHORIZATION_REJECTED;
CM_USER_UNKNOWN; or
CM_RATING_FAILED.

29. The method of claim 27, wherein the submission of the Rule-Failure-Code over the Gx reference point is triggered by Event-Trigger Attribute-Value Pair (AVP) CREDIT_MANAGEMENT_SESSION_FAILURE.

30. The method of claim 27, wherein a Rule-Failure-Code is introduced indicating that a subscriber credit limit is being reached.

31. The method of claim 27, further comprising receiving, from the PCRF, an indication that at least one Policy and Charging Control (PCC) rule is changed or removed for the subscriber in response to the Rule-Failure-Code submitted to the PCRF.

32. A method of a Policy and Charging Rules Function (PCRF) in a communications network of acquiring Online Charging System (OCS) charging information of a subscriber, the method comprising:
receiving, over a Gx reference point from a Policy and Enforcement Rules Function (PCEF), a Rule-Failure-Code indicating the OCS charging information of the subscriber requesting a service in the communications network.

33. The method of claim 32, wherein the Rule-Failure-Code is:
CM_END_USER_SERVICE_DENIED;
CM_CREDIT_CONTROL_NOT_APPLICABLE;
CM_AUTHORIZATION_REJECTED;
CM_USER_UNKNOWN; or
CM_RATING_FAILED.

34. The method of claim 33, further comprising submitting, to an Application Function (AF) over an Rx reference point, a message notifying the AF about the Rule-Failure-Code received from the PCEF.

35. The method of claim 32, wherein the reception of the Rule-Failure-Code over the Gx reference point is triggered by Event-Trigger Attribute-Value Pair (AVP) CREDIT_MANAGEMENT_SESSION_FAILURE.

36. The method of claim 32, wherein a Rule-Failure-Code is introduced indicating that a subscriber credit limit is being reached.

37. The method of claim 32, further comprising submitting an indication that at least one Policy and Charging Control (PCC) rule is changed or removed for the subscriber in response to the Rule-Failure-Code received from the PCEF.

38. A Policy and Charging Enforcement Function (PCEF) configured to indicate to a Policy and Charging Rules Function (PCRF) charging information of a subscriber received from an Online Charging System (OCS) in a communications network, the PCEF comprising:
processing circuitry;
memory containing instructions executable by the processing circuitry whereby the PCEF is operative to:
receive, from the OCS, the charging information of the subscriber requesting a service in the communications network; and
submit, over a Gx reference point to the PCRF, a Rule-Failure-Code indicating the charging information received from the OCS.

39. The PCEF of claim 38, wherein the Rule-Failure-Code is:
CM_END _USER_SERVICE_DENIED;
CM_CREDIT_CONTROL_NOT_APPLICABLE;
CM_AUTHORIZATION_REJECTED;
CM_USER_UNKNOWN; or
CM_RATING_FAILED.

40. The PCEF of claim 38, wherein the submission of the Rule-Failure-Code is triggered by Event-Trigger Attribute-Value Pair (AVP) CREDIT_MANAGEMENT_SESSION_FAILURE.

41. The PCEF of claim 38, wherein a Rule-Failure-Code is introduced indicating that a subscriber credit limit is being reached.

42. The PCEF of claim 38, wherein the instructions are such that the PCEF is operative to receive, from the PCRF, an indication that at least one Policy and Charging Control (PCC) rule is changed or removed for the subscriber in response to the Rule-Failure-Code submitted to the PCRF.

43. A Policy and Charging Rules Function (PCRF) configured to acquire Online Charging System (OCS) charging information of a subscriber in a communications network, the PCRF comprising:
processing circuitry;
memory containing instructions executable by the processing circuitry whereby the PCRF is operative to:
receive, over a Gx reference point from a Policy and Enforcement Rules Function (PCEF), a Rule-Failure-Code indicating the OCS charging information of the subscriber requesting a service in the communications network.

44. The PCRF of claim 43, wherein the Rule-Failure-Code is:
CM_END_USER_SERVICE_DENIED;
CM_CREDIT_CONTROL_NOT_APPLICABLE;
CM_AUTHORIZATION_REJECTED;
CM_USER_UNKNOWN; or
CM_RATING_FAILED.

45. The PCRF of claim 44, wherein the instructions are such that the PCRF is operative to submit to an Application Function (AF), over an Rx reference point, a message notifying the AF about the Rule-Failure-Code received from the PCEF.

46. The PCRF of claim 43, wherein the reception of the Rule-Failure-Code over the Gx reference point is triggered by Event-Trigger Attribute-Value Pair (AVP) CREDIT_MANAGEMENT_SESSION_FAILURE.

47. The PCRF of claim 43, wherein a Rule-Failure-Code is introduced indicating that a subscriber credit limit is being reached.

48. The PCRF of claim 43, wherein the instructions are such that the PCRF is operative to submit an indication that at least one Policy and Charging Control (PCC) rule is changed or removed for the subscriber in response to the Rule-Failure-Code received from the PCEF.

49. A non-transitory computer readable recording medium storing a computer program product for controlling a Policy and Charging Enforcement Function (PCEF) in a communications network for indicating, to a Policy and Charging Rules Function (PCRF), charging information of a subscriber received by the PCEF from an Online Charging System (OCS), the computer program product comprising software instructions which, when run on processing circuitry of the PCEF, causes the PCEF to:
receive, from the OCS, the charging information of the subscriber requesting a service in the communications network; and
submit, over a Gx reference point to the PCRF, a Rule-Failure-Code associated with the charging information received from the OCS.

50. A non-transitory computer readable recording medium storing a computer program product for controlling a Policy and Charging Rules Function (PCRF) in a communications network for acquiring Online Charging System (OCS) charging information of a subscriber, the computer program product comprising software instructions which, when run on processing circuitry of the PCRF, causes the PCRF to:
receive, over a Gx reference point from a Policy and Enforcement Rules Function (PCEF), a Rule-Failure-Code indicating the OCS charging information of the subscriber requesting a service in the communications network.
